(19) United States
(12) Patent Application Publication
(10) Pub. No.: US 2006/0076537 A1
(43) Pub. Date: Apr. 13, 2006

(54) Rhenium compounds

(75) Inventors: Victor Christou, Stanford, CA (US); Scott Edward Watkins, Melbourne (AU)

Correspondence Address: QUARLES & BRADY LLP, 411 E. WISCONSIN AVENUE, SUITE 2040, MILWAUKEE, WI, 53202-4497, US

(73) Assignee: Isis Innovation Limited, Oxford (GB)

(21) Appl. No.: 10/507,802

(22) PCT Filed: Mar. 17, 2003
(86) PCT No.: PCT/GB03/01189

§ 371 Date: Jan. 3, 2005

(30) Foreign Application Priority Data
Mar. 15, 2002 (GB) 0206169.5

(51) Int. Cl. C09K 11/06

(52) U.S. Cl. 252/301.16

(57) ABSTRACT

An organic electroluminescent device is described which comprises a compound having a skeleton of the formula: 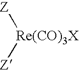 which skeleton can comprise one or more additional aromatic rings, wherein each of Z and Z′, which may be the same or different, represents a nitrogen-containing aromatic ring such that the Z and Z′ rings either together form a conjugated system, optionally with one or more additional aromatic rings, or at least one of Z and Z′ form a conjugated system with one or more additional aromatic rings to which Z and Z′ is attached, with the proviso that, (a) when the two said rings are pyridyl rings and are connected to one another ortho to the nitrogen atoms then (i) at least one said ring is substituted by at least one electron withdrawing substituent which is a hydrocarbon aryl group or (ii) at least one said ring is fused to another aromatic ring to which the other pyridyl ring is not fused or (iii) the two said rings together form a phenanthroline ring system which is substituted by at least one electron withdrawing substituent which is in the 2, 4, 5, 6, 7 or 9 position, or (b) the two said rings are such that either (i) at least one of them contains at least one further nitrogen atom or (ii) they are fused to another aromatic ring which contains at least one nitrogen atom, and X represents an anionic or neutral coligand.

This invention relates to rhenium compounds and, in particular, rhenium compounds which are useful as emitting materials in electroluminescent (EL) devices.

Numerous metal complexes have been proposed as emitting materials in EL devices. One of the difficulties is that although many such compounds show promise when tested in solution, they are not efficient emitters in the solid state. In addition, although there are many candidates for use as emitters at the green portion of the spectrum, including green phosphorescent materials such as iridium tris(phenylpyridine), there is a marked lack of emitters towards the red end of the spectrum. Only a few red phosphorescent materials have been demonstrated for use in EL devices. Red emitting 2,3,7,8,12,13,17,18-octaethyl-21H,23H-porphine platinum has a relatively long decay lifetime and in many ways is too deep a red colour which reduces useful efficiency. Some red emitting Ir compounds such as iridium (III)bis(2-(2′-benzothienyl)pyridinato-N,C^{3′})(acetylacetonate) are also known but they have not yet been proved to have sufficient lifetime in devices and there is still scope for efficiency improvements. There is, therefore, a need for efficient emitters which emit red light with good colour purity, particularly for use in full colour displays and that have good efficiency in EL devices. It is therefore an object of the invention to provide materials emitting towards the red region of the spectrum, particularly materials with good red emission that are suitable for use in full colour displays, and that have good efficiency and short luminescence decay lifetimes.

It has been found, according to the present invention, that certain rhenium complexes possessing three coordinating carbonyl ligands together with a bi-dentate, diimine-type ligand can be used in EL devices which emit generally in the yellow to red region of the spectrum. According to the present invention there is provided an electroluminescent device which comprises a compound having a skeleton of the formula: 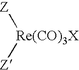
which skeleton can comprise one or more additional aromatic rings, wherein each of Z and Z′, which may be the same or different, represents a nitrogen-containing aromatic ring such that the Z and Z′ rings either together form a conjugated system, optionally with one or more additional aromatic rings, or at least one of Z and Z′ form a conjugated system with one or more additional aromatic rings to which Z and Z′ is attached, with the proviso that, (a) when the two said rings are pyridyl rings and are connected to one another ortho to the nitrogen atoms then (i) at least one said ring is substituted by at least one electron withdrawing substituent which is a hydrocarbon aryl group or (ii) at least one said ring is fused to another aromatic ring to which the other pyridyl ring is not fused or (iii) the two said rings together form a phenanthroline ring system which is substituted by at least one electron with-drawing substituent which is in the 2, 4, 5, 6, 7 or 9 position, or (b) the two said rings are such that either (i) at least one of them contains at least one further nitrogen atom or (ii) they are fused to another aromatic ring which contains at least one nitrogen atom, and X represents an anionic or neutral coligand The EL device results from the compounds of the invention, such as 4,7-diphenyl-2,9-dimethyl-1,10-phenanthroline (compound 1), are red shifted and significantly more efficient than the prior art EL results from the Re compound shown in Syn Met. 118, 2001, 175-179 which does not posses an electron withdrawing substituent.

The compounds where the two said rings are such that either (i) at least one of them, and preferably only one of them, contains at least one further nitrogen atom or (ii) they are fused to another aromatic ring which contains at least one nitrogen atom i.e. such compounds containing at least 3, for example 4, ring nitrogen atoms are novel apart from 5,6-diphenyl-32-pyridyl)-1,2,4-triazine and 3,5,6-tri(2-pyridyl)-1,2,4-triazine, when X is chlorine and form another aspect of the present invention. When we say “fused to another aromatic ring which contains at least one nitrogen atom” we mean directly fused. Typically the nitrogen-containing rings are 6-membered, especially when they contain 2 or more hetero atoms. If the ring is 5 membered and possesses more than one heteroatom this second heteroatom is preferably nitrogen. Indeed in one embodiment all the heteroatoms are nitrogen. It is preferred that when the nitrogen-containing ring contains 2 or more nitrogen atoms it is a 6-membered ring. Preferably the ring system has the structure: 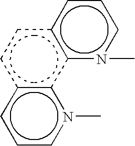
The dotted lines represent optional bonds. Generally the system will be conjugated, for example by a single bond connecting the two pyridyl rings, by a third aromatic ring or by a —C′═C′— link.

If the nitrogen-containing rings are pyridyl rings then they are typically linked together via their ortho carbon atoms or connected by a —C″═C″— link via carbon atoms meta to the nitrogen atoms. Alternatively they can be fused to a benzene ring to form a phenanthroline ring or to a nitrogen-containing aromatic ring. If one of the nitrogen-containing rings is not a pyridyl ring then it can contain one or more additional nitrogen atoms.

Thus typical ring systems include the following: 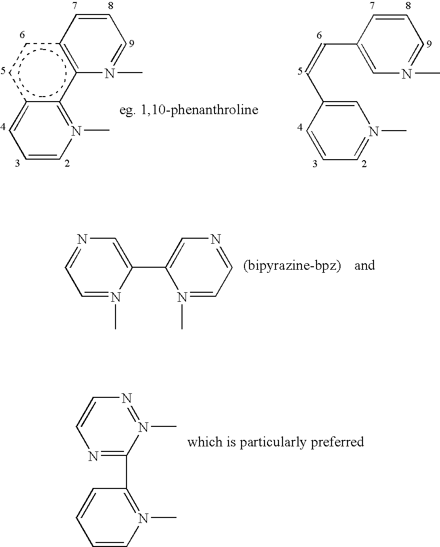
as well as two unconnected 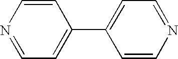
   rings, as
in [Re(CO)₃(4,4′-bipyridyl)₂Cl] as shown below

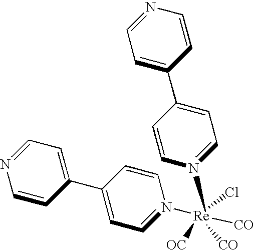

A common feature of the compounds of the invention is that the conjugation of the Z-Z′ ligand system has been extended or modified to produce the red shift and increase in luminous efficiency.

When the ring system is bipyridyl or phenanthroline, it is necessary for at least one ring to be substituted by an electron withdrawing substituent unless one of the rings is fused to an aromatic ring as in:

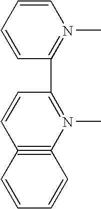

Additionally when the ring system is bipyridyl the electron withdrawing substituent is a hydrocarbon aryl group (which can be substituted) and when the ring system is a phenanthroline ring system the electron withdrawing substituent is in the 2, 4, 5, 6, 7 or 9 position.

Given the relatively low sensitivity of the HOMO energy to changes to the diimine ligand the emission energy of Re(I) complexes is, broadly speaking, proportional to the reduction potential of the ligand. In general, Re(I) complexes emit in the yellow-green region of the spectrum. The colour of this emission can therefore be red shifted by lowering the LUMO energy i.e. by making the ligand reduction potential more positive. Such a change can be made either by changing the ligand itself or by introducing electron withdrawing substituents. In particular it is preferred that there are two substituents on at least one of the rings and at least one of these substituents is an electron withdrawing group. The presence of two substituents allows greater control over the energy levels, can improve the processing properties, and in some cases, such as when the substituents are phenyl groups, can increase the luminescence quantum yield.

Thus for all the ring systems which can be used the presence of an electron withdrawing substituent is generally beneficial. The definition of an electron withdrawing group is the tendency for an atom or group of atoms to attract electron density from the ligand towards itself relative to a hydrogen atom such that atoms or groups of atoms with a greater tendency to attract electron density towards themselves than a hydrogen atom are known as electron withdrawing groups. Examples of electron withdrawing groups include nitro; nitroso; cyano; thiocyano; cyanato; aldehyde; ether, carboxylic acid; azide; aryl, such as phenyl; heteroaryl, such as pyridyl, e.g. 4-pyridyl, pyrazole, furan, thiophene; halogen, e.g. fluorine, chlorine, bromine, iodine; ester, such as alkoxycarbonyl, e.g. ethoxycarbonyl; chalcogenoester, such as alkyl chalcogenoester, e.g. CH₃EO₂, or aryl chalcogenoester, e.g. PhEO₂ (where E can be S, Se or Te); fluoroalkyl, such as trifluoroalkyl, e.g. trifluoromethyl and pentafluoroethyl; hypophosphate, e.g. H₂PO₃; sulfonate, such as aryl sulfonate, e.g. p-CH₃PhSO₃; acyl halide, e.g. COCl; amide, such as CONH₂, CONHR, CONR₂ (where R can in turn be hydrogen or any organic group such as alkyl or aryl); substituted N-oxide such as NOR, e.g. NOCH₃; hydrazide, such as NR—NR′₂ (where R and R′ can in turn be hydrogen or any organic group such as allyl or aryl); quaternary amine, such as tetralkylammonium, e.g. Et₄N; silyl, such as SiR₃ (where R can in turn be hydrogen or any organic group such as alkyl or aryl); substituted, bivalent chalcogenide, such as alkyl seleno or sulfonyl groups, e.g. CH₃Se, CF₃S as well as trifluoromethylphenyl, pentafluoroethylphenyl and pentafluorophenyl. Of course all of these electron withdrawing groups can be substituted.

In some instances the electron withdrawing group or groups may be so strong such that the shift goes beyond the red region; examples of such groups include NO₂ and oxadiazole. In such circumstances it may be desirable to include an electron donating substituent as well; suitable such substituents include allyl such as methyl and t-butyl, alkoxy such as methoxy, amino or substituted amino such as diethylamino, as well as amido, typically aliphatic acyl amido such as acetamido. The alkyl groups which may form part of, or be, a substituent typically have 1 to 6, for example 1 to 4, carbon atoms.

Phenyl substituents, in particular, have been found to be beneficial since not only do they shift the emission towards the red position region but their presence can also increase the luminescence quantum yield. A phenyl group substituted by one (or more) fluorine or fluorine-containing groups, for example trifluoromethyl, has a stronger electron withdrawing effect than a phenyl group and shifts the emission further to the red region.

Substituents can be present on any position of the rings. However, it is preferred that the electron withdrawing substituent is not meta to the N—Re bond, i.e. is not in the 3 position for pyridyl and phenanthroline ligands, because the electronic effect of an electron withdrawing group at the meta position is much less than it would be in the ortho or para positions, and the intention in this invention is that the electron withdrawing group is present to modify the LUMO level of the diimine ligand to control the emission colour. Preferably substituents are para to the ring nitrogen atom i.e. in the 4 position for bipyridyl. For phenanthroline typical positions are 2, 4, 5, 6, 7 and 9 with the 4 and 7, 5 and 6; or 2 and 9, pairs being generally preferred. For the preferred triazine-pyridyl system the substituents are preferably in the triazine ring, a particularly preferred diimine system is 2-(2-pyridyl-4,5-diphenyl-triazine-) (dppt).

When the Z and Z′ rings are the same it is preferred that there is an electron withdrawing group on both Z and Z′. It is further preferred that when the Z and Z′ rings are the same there is the same type of substituent at the same relative positions on each.

As indicated above, the coligand X is neutral or anionic (if X is neutral then a non-coordinating counter anion is required to form a stable complex). A wide variety of coligands can be used including nitrate, nitrite, perchlorate, iodate, bromate, chlorate, chlorite, hypochlorite, hypobromite, bicarbonate, trifluoromethylsulfonate, hydride, dihydrogen phosphate, hydrogen sulfate; also hydrocarbonyl groups such as phenyl, alkyl and substituted alkyl eg aralkyl such as benzyl; also anions from organic acids such as acetate and formate; also sulfonates including alkyl and aryl sulfonates; also cyanide, cyanate, thiocyanate, hydroxide and amide; also inorganic anions such as permanganate; also alkyl and aryl alcohols, thiols and amines; also heteroaromatic groups such as pyrroles, imidazoles, pyrazoles and carbenes: also borates such as trispyrazolyl borates. However X is preferably a halide including chloride, fluoride, bromide and iodide. It has surprisingly been found that in the solid state the difference in luminescence efficiency between complexes having a halide ligand rather than a neutral ligand is nowhere near as great as solution data would suggest.

Varying the halide from chloride to bromide to iodide leads to only slight shifts in the HOMO and LUMO energy levels, but varying the halide ion affects both the lifetime and the quantum efficiency of the emission. Qualitative measurements on complexes 3, 4 and 9—see below (which all have X═Br) and complex 13 (which has X═I) support the conclusion that the heavier halides give more efficient emissions.

A further advantage of halide-based over neutral-ligand based complexes is long-term photostability of the complexes. In ambient conditions under a UV lamp halide based complexes have exhibited no observable decomposition whereas a sample of 7 (see below), which contains a pyridyl coordinating ligand and a non-coordinating perchlorate anion, in the solid state showed marked photodecomposition in its spectra on standing in air for several months. Enhanced photostability should lead to intrinsically stable materials for electroluminescent devices. Photostability also provides a route to designing photopolymerisable compounds for photopatternable electroluminescent devices. Thus if they possess a radical, cationic or anionic polymerisable group, especially a photopolymerisable group as a substituent, then the compounds can be polymerised to form a polymer possessing pendant luminescent Re-containing ring systems. Examples of suitable photopolymerisable substituent groups are olefin groups such as an acrylate derivative or vinyl, or strained ring systems such as an oxetane or epoxide, or other known one or two-component systems.

Apart from forming polymers, the rhenium complexes can also form part of dendrimers such as those of the type disclosed in WO99/21935 Thus the complex possesses one or more substituents, which forms part of a dendritic structure such that the molecule is a dendrimer. The use of suitable dendritic branches can give the molecules good solubility and film forming properties, which are useful if solution processing techniques are to be used in the manufacture of the EL device. The dendrimer can comprise at least one coordinating group which is not dendritic. In a preferred embodiment a dendrimer of the present invention win comprise one coordinating group which is dendritic and 3 CO ligands and an X ligand bound to the Re ion. The dendrite(s) is/are preferably bound to the diimine-type ligand and the CO and X ligands are not dendritic. Such dendrimers can be prepared using the techniques disclosed in WO 99/21935 to which reference should be made for further details.

The compounds used in the present invention can generally be prepared by reacting the desired diimine-type ligand with a rhenium complex of the formula Re(CO)₅X. Typically they can be reacted by using roughly equimolar amounts, with heating, typically under reflux in a nonpolar organic solvent such as toluene or a polar solvent such as methanol or chloroform, in an inert atmosphere, for example argon. Generally the desired complex can be obtained as a precipitate on cooling. The precipitate can be washed and dried and, if desired, further purified by vacuum sublimation.

In its simplest form, an organic light emitting or electroluminescent device of this invention can be formed from a light emitting layer sandwiched between two electrodes at least one of which must be transparent to the emitted light. Typically, the device can be formed from a transparent substrate layer, a transparent electrode, a layer of light emitting material, and a second electrode. In a conventional structure the transparent electrode is the anode and the final electrode is the cathode. The transparent substrate is typically made of glass, but could be a transparent plastic such as PET. The transparent anode is preferably made from indium tin oxide (ITO), although other similar materials as well as conducting polymers such as PANI (polyaniline) may also be used. The cathode is generally made of a low work function metal or alloy such as Al, Ca, Mg, Li, or MgAg. As is well known, other layers may also be present, including a hole transporting material and/or an electron transporting material. In an alternative configuration, the substrate may be an opaque material such as silicon, and the light is emitted through the opposing electrode.

In one embodiment, the complexes of the present invention form a light emitting layer between the electrodes. A light emitting device can be formed with a single layer containing one or more compounds of this invention, optionally mixed with one or more other molecular, dendritic or polymeric species between the electrodes, but other layers may also be present. In particular there may be a hole transporting layer(s) between the anode and the light emitting layer and/or an electron transporting material between the light emitting layer and the cathode. Typical hole transporting materials include triarylamines such as TPD or α-NPD, or PEDOT:PSS. It can be beneficial to include a hole blocking/electron transporting layer between the emissive layer and the cathode. Examples of hole blocking materials include 2,9 dimethyl-4,7-diphenyl-1,10-phenanthroline (BCP) and 2,2′,2″-(1,3,5-phenylene)tris[1-phenyl-1H-benzimidazole] (TPBI). Examples of electron transporting materials include oxadiazoles or aluminium tris(8-hydroxyquinolate). In addition there may be an electron injecting layer deposited before the cathode, suitable materials include LiF. Addition of suitable hole or electron transporting layers can improve the efficiency and/or lifetime of the device.

The layer comprising the compound of the present invention may consist of the compound or the compound can be added into a host forming a blend. Typical host materials include a phosphorescent matrix such as a benzophenone or an acetophenone derivative, for example 1,1,1-triphenylacetophenone or 4,4′-dimethyloxybenzophenone, or a lanthanide complex whose ligand has a higher triplet energy than that of the complex of this invention, or an oxadiazole such as 1,3-bis[5-(4-tert-butylphenyl)-[1,3,4]oxadiazol-2-yl]-benzene or a carbazole such as 4,4′-bis(carbazol-4-yl) biphenyl (CBP), or 4,4′,4″-tri(N-carbazolyl)triphenylamine (TCTA).

Devices containing the compounds of the invention can be prepared in a conventional manner. In a preferred embodiment the compounds are deposited on the substrate by physical vapour deposition (evaporation under reduced pressure). In another embodiment the compounds or blend of compounds are deposited from solution, for example by spin-coating, inkjet printing, or other solution processing techniques.

The following Examples further illustrate the present invention.

The following compounds were prepared:

### EXAMPLES

The general synthesis of the [Re(I)(CO)₃(L)X]-type complexes (X═Cl, Br) is as follows:

A stirred suspension of equimolar amounts of [Re(CO)₅X] and the diimine-type ligand in toluene was heated at reflux under an Ar atmosphere for 2 hrs. Typically, the suspension changed colour and became a solution within 5-10 mins. On cooling a precipitate formed which was collected by filtration, washed with pentane and dried under vacuum The complexes were further purified by vacuum sublimation. Chemical yields were between 70 and 90%.

### Example 1

[Re(CO)₃(2,9-Me₂-4,7-Ph₂phen)Cl] (1)

The reaction of 2,9-dimethyl-4,7-diphenyl-1,10-phenanthroline with Re(CO)₅Cl gave a yellow powder. The product was purified by sublimation at 265° C. at 9′ 10⁻⁶ mbar. Found C, 51.82; H, 2.63; N, 4.09; C₂₉H₂₀ClN₂O₃Re requires C, 52.29; H, 3.03; N, 4.21%. δ_{H}(CDCl₃) 7.87 (2H, s), 7.70 (2H, s), 7.60-7.40 (10H, m), 3.40 (6H, s). IR: (nujol) ν_{CO} (cm⁻¹) 2013, 1915, 1879, 1862. Emission spectra: CH₂Cl₂ (λₑₓ=330 nm) λₘₐₓ=576 nm, CIE: 0.425, 0.516; powder (λₑₓ=435 nm) λₘₐₓ=532 nm, CIE: 0.338, 0.620.

### Example 2

[Re(CO)₃(dppt)Cl] (2)

The reaction of 3-(2-pyridyl)-5,6-diphenyl-1,2,4-triazine (dppt) with Re(CO)₅Cl gave an orange powder. The product was purified by sublimation at 280° C. at 1′ 10⁻⁶ mbar. Found C, 44.83; H, 2.30; N, 9.12; C₂₃H₁₄ClN₄O₃Re requires C, 44.84; H, 2.29; N, 9.09%. δ_{H} (CDCl₃) 9.04 (1H, d), 8.70 (1H, d), 8.11 (1H, t), 7.70-7.00 (11H, m). Emission spectrum powder (λₑₓ=435 nm) λₘₐₓ=617 nm, CIE: 0.632, 0.366.

### Example 3

[Re(CO)₃(2,9-Me₂-4,7-Ph₂phen)Br] (3)

The reaction of 2,9-diethyl-4,7 diphenyl-1, 10-phenanthroline with Re(CO)₅Br gave a yellow powder. The product was purified by sublimation at 260° C. at 5′ 10⁻⁷ mbar. Found C, 51.53; H, 3.95; N, 3.28; C₂₉H₂₀BrN₂O₃Re requires C, 49.02; H, 2.84; N, 3.94%.

### Example 4

[Re(CO)₃(dppt)Br] (4)

The reaction of 3-(2-pyridyl)-5,6-diphenyl-1,2,4-triazine (dppt) with Re(CO)₅Br gave an orange powder. δ_{H} (CDCl₃) 9.12 (1H d), 8.76 (1H d), 8.17 (1H, t), 7.80-7.10 (11H, m). Emission spectra: CHCl₃, (λₑₓ=519 nm) λₘₐₓ=624 nm, CIE: 0.655, 0.345; powder (λₑₓ=440 nm) λₘₐₓ=619 nm, CIE: 0.600, 0.395.

### Example 5

[Re(CO)₃(2,4,7,9-Ph₄-phen)Cl] (5)

2,9,4,7-tetraphenyl-1,10-phenanthroline was prepared from phenyllithium and 4,7-diphenyl-1,10-phenanthroline as described by Sauvage et al. (Tet. Lett., 23, 50, 1982, 5291). Found C: 89.30, H: 4.22, N: 5.53; C₃₆H₂₄N₂ requires C: 89.23, H: 4.99, N: 5.78%. δ_{H} (CDCl₃) 8.52 (4H, d), 8.09 (2H, s), 7.81 (2H, s), 7.65-7.55 (16H, m). EI MS 484.1 (M⁺).

The reaction of 2,9,4,7-tetraphenyl-1,10-phenanthroline with Re(CO)₅Cl gave an orange powder. The product was purified by sublimation at 275° C. at 3´10⁻⁶ mbar. Found C: 60.22, H: 3.05, N: 3.51; C₃₉H₂₄ClN₂O₃Re requires C: 59.27, H: 3.06, N: 3.54%. δ_{H}(CDCl₃) 8.05 (2H, s), 7.95 (2H, s), 7.93-7.87 (4H, m), 7.65-7.45 (18H, m). IR: (solid) ν_{CO} (cm⁻¹) 2018, 1917, 1869. EI MS 790.1 (M⁺). Emission spectra: CH₂Cl₂ (λₑₓ=450 nm) λₘₐₓ=591 mm, CIE: 0.545, 0.452; powder (λₑₓ=475 nm) λₘₐₓ=592 nm, CIE: 0.567, 0.432.

### Example 6

### Comparative Example

[Re(CO)₃(2,4,7,9-Me₄phen)(4,4′bpy)](CF₃SO₃) (6)

This complex was prepared as described by Guarr et al (Inorg. Chem., 1992, 4346). Emission spectrum λₘₐₓ=527 nm, φ=0.57 (MeCN, 298 K). The yellow powder was sublimed at 300° C. at 1′ 10⁻⁶ mbar. ¹H nmr and elemental analysis of the sublimation product is consistent with the formulation [e(CO)₃(Me₄phen)](CF₃SO₃) where the 4,4′bpy ligand has been lost.

The emission wavelength (in solution) of this comparative example is undesirably blue shifted relative to the emission wavelengths of the compounds of the invention.

### Example 7

[Re(CO)₃(2,9-Me₂-4,7-Ph₂phen)py][ClO₄] (7)

This complex was prepared as described by DeGraff et al. (Inorg. Chem., 1993, 5629). Emission spectrum: λₑₘ×555 nm, φ=0.32 (CH₂Cl₂, 298 K).

### Example 8

[Re(CO)₃(2,2′-bpz)Cl] (8)

2,2′-Bipyrazine was prepared as described by Lever et al. (Inorg. Chem., 1982, 2276). The reaction of 2,2′-bipyrazine with Re(CO)₅Cl gave an orange powder. Found C, 28.62; H, 1.27; N, 12.18; C₁₁H₆ClN₄O₃Re requires C, 28.48; H, 1.30; N, 12.08%. δ_{H} (CDCl₃) 10.15 (2H, s), 9.15 (2H, d), 9.00 (2H, d). IR: (nujol) ν_{CO} (cm⁻¹) 2022, 1938, 1911. Emission spectrum powder (λₑₓ=400 nm) λₘₐₓ=635 nm, CIE: 0.674, 0.326.

### Example 9

[Re(CO)₃(2,2′-bpz)Br] (9)

2,2′-Bipyrazine was prepared as described by Lever et al. (Inorg. Chem., 1982, 2276). The reaction of 2,2′-bipyrazine with Re(CO)₅ Br gave an orange powder. Found C, 26.16; H, 1.92; N, 11.24; C₁₁H₆BrN₄O₃Re requires C, 25.99; H, 1.19; N, 11.02%: δ_{H} (CDCl₃) 9.69 (2H, s), 9.06 (2H, d), 8.87 (2H, d): Emission spectrum: powder (λₑₓ=450 nm) λₘₐₓ=641 nm, CIE: 0.670, 0.329.

### Example 10

[Re(CO)₃ {2,9-(4-CF₃Ph)₂-4,7-Ph₂phen}Cl] (10)

The novel ligand, 2,9-bis(4-trifluoromethylphenyl)-4,7-diphenyl-1,10-phenanthroline, was prepared from 4-bromobenzotrifluoride and 4,7-diphenyl-1,10-phenanthroline by the method of Sauvage et al. (Tet. Lett., 23, 50, 1982, 5291). δ_{H} (CDCl₃) 8.59 (4H, d), 8.11 (2H, s), 7.95-7.80 (8H, m), 7.70-7.40 (12H, m), δ_{F} (CDCl₃) −63.4 (s).

The reaction of 2,9-bis(4-trifluoromethylphenyl)-4,7-diphenyl-1,10-phenanthroline with Re(CO)₅Cl gave an orange powder. The product was purified by sublimation at 275° C. at 5×10⁻⁶ mbar. δ_{H} (CDCl₃) 8.11 (2H, s), 8.00-7.80 (10H, m), 7.70-7.50 (10H, m), δ_{F} (CDCl₃) −63.4 (s), IR: (solid) ν_{CO} (cm⁻¹) 2028, 1936, 1877. Emission spectra: CH₂Cl₂ (λₑₓ=451 nm) λₘₐₓ=596 nm, CIE: 0.554, 0.442; powder (λₑₓ=468 nm) λₘₐₓ=585 nm, CIE: 0.535, 0.461.

### Example 11

[Re(CO)₃ {2,9-(3-CF₃Ph)₂-4,7-Ph₂phen}Cl] (11)

The novel ligand, 2,9-bis(3-trifluoromethylphenyl)-4,7-diphenyl-1,10-phenanthroline, was prepared from 3-bromobenzotrifluoride and 4,7-diphenyl-1,10-phenanthroline by the method of Sauvage et al. (Tet. Lett., 23, 50, 1982, 5291). δ_{H} (CDCl₃) 8.83 (2H, br s), 8.68 (2H, br d), 8.11 (2H, s), 7.86 (2H, s), 7.80-7.65 (4H, m), 7.65-7.50 (10H, m), δ_{F} (CDCl₃) −63.1 (s).

The reaction of 2,9-bis(3-trifluoromethylphenyl)-4,7-diphenyl-1,10-phenanthroline with Re(CO)₅Cl gave an orange powder. The product was purified by sublimation at 265° C. at 5×10⁻⁶ mbar. Found C, 53.22; H, 2.38; N, 3.04; C₄₁H₂₂ClF₆N₂O₃Re requires C, 53.16; H, 2.39; N, 3.02%. OH (CDCl₃) 8.11 (2H, s), 8.10-7.65 (10H, m), 7.58 (10H, br s), δ_{F} (CDCl₃) −63.1 (s). IR: (solid) ν_{CO} (cm⁻¹) 2020, 1926, 1892. Emission spectra: CH₂Cl₂ (λₑₓ=396 nm) λₘₐₓ=635 nm, CIE: 0.626, 0.373; thin film (λₑₓ=396 nm) λₘₐₓ=610 nm, CIE: 0.569, 0.429.

### Example 12

[Re(CO)₃ (2,2′-biq)Cl] (12)

The reaction of 2,2′-biquinoline (2,2′-biq) with Re(CO)₅Cl gave a red powder as described by Wrighton et al. (J. Amer. Chem. Soc., 1974, 998). δ_{H} (CDCl₃) 8.95 (2H, d), 8.58 (2H, d), 8.39 (2H, d), 8.10-7.90 (4H, m), 7.68 (2H, tr).

### Example 13

[Re(CO)₃(2,9-Me₂-4,7-Ph₂phen)I] (13)

One molar equivalent of silver taifiate was added to a suspension of 1 in acetone. The mixture was heated at reflux under Ar for 2 hrs. The yellow/orange mixture was cooled and the white solid removed by filtration. The solvent from the filtrate was removed under vacuum and the residue redissolved in toluene. 10 molar equivalents of sodium iodide was added to the solution and the mixture heated at reflux for 8.5 hrs. The mixture was filtered and the solvent from the filtrate removed under vacuum. The product was recrystallised from dichloromethane/pentane to give a green powder in 66% yield The product was purified by sublimation at 260° C. at 2′ 10⁻⁶ mbar. Found C, 45.80; H, 1.89; N, 3.87; C₂₉H₂₀IN₂O₃Re requires C, 45.98; H, 2.66; N, 3.70%. δ_{H} (CDCl₃) 7.88 (2H, s), 7.71 (2H, s), 7.60-7.40 (10H, m), 3.40 (6 H, s). Emission spectra: CH₂Cl₂ (λₑₓ=313 nm) λₘₐₓ=569 nm, CIE: 0.463, 0.525; powder (λₑₓ=400 nm) λₘₐₓ=527 nm, CIE: 0.293, 0.636. 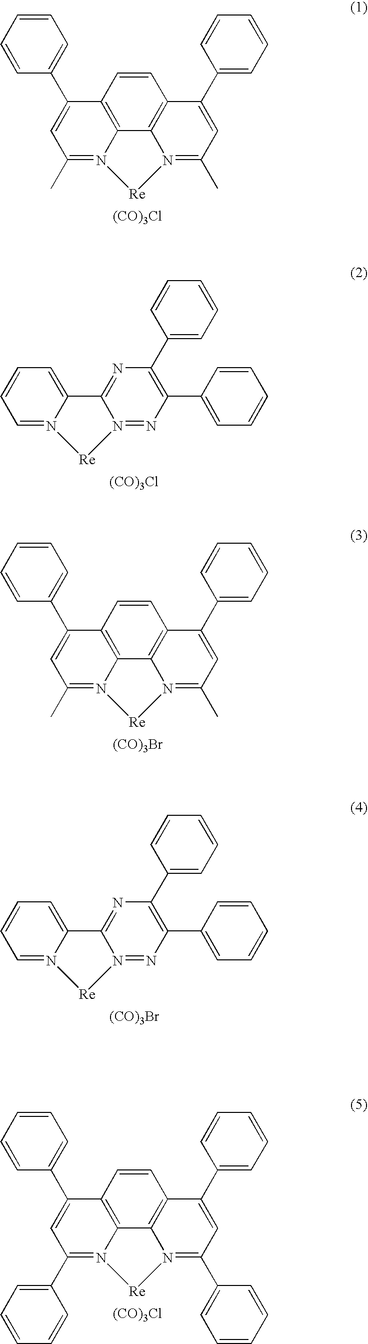 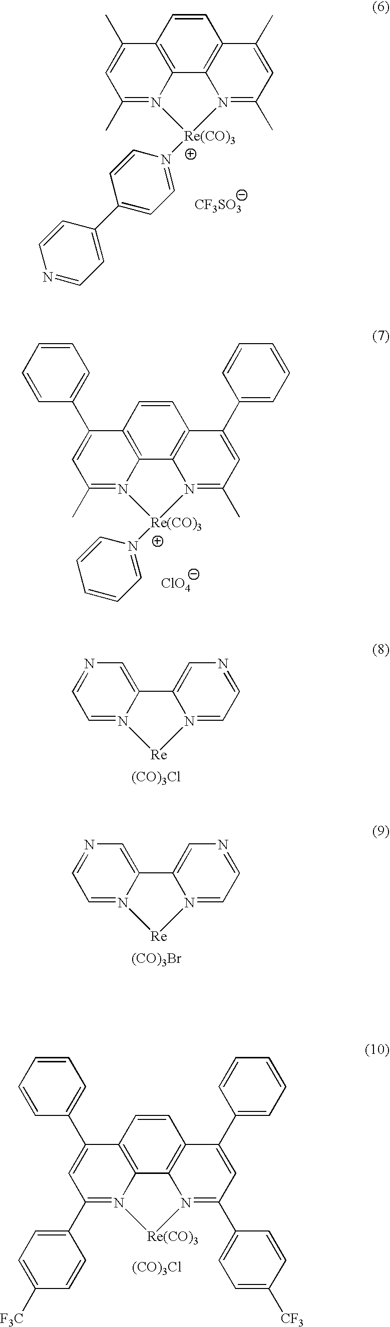 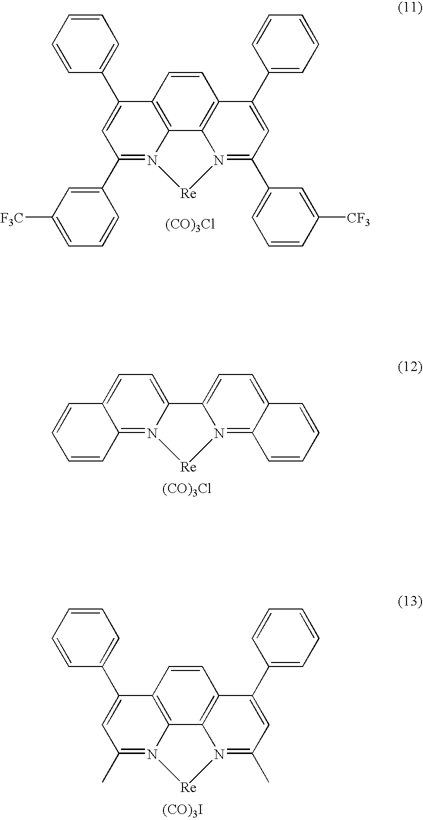
Volatility and Stability

Complexes 1-3, 11 and 13 were all sublimed under high vacuum at temperatures between 250 and 300° C. Whilst a small amount of decomposition was observed for all complexes, the elemental analyses and spectroscopic data for the sublimed products are consistent with the formulations given. Complexes 5 and 10 were sublimed at around 275° C. but exhibited decomposition and showed evidence of free ligand (as judged by the ¹H nmr spectra) in the sublimed products.

Analysis of the product obtained following the sublimation of complex 6 was consistent with the loss of the 4,4′bpy fragment and the formulation [Re(CP)₃(Me₄phen)](CF₃SO₃).

An attempt to sublime 7 under high vacuum resulted in complete decomposition of the complex at around 200° C.

Samples of these complexes were left in the solid state under a UV lamp in air for months and no decomposition was observed. However, a sample of 7, on standing as a solid in atmospheric conditions and visible light over a period of weeks, exhibited significant changes in both its absorption and emission spectra.

Electrochemistry

As mentioned above, aside from altering the substituents, changes to the diimine ligands themselves is another way of altering the LUMO energy, and thus the emission energy, of the Re(I) complexes.

Oxidation and reduction potentials were determined for a series of complexes with different diimine ligands and their values compared with bipyridyl and phenanthroline. The results obtained are set out below:

| | | Oxidation | Reduction | |
|---|---|---|---|---|
| | Observable redox | E_{1/2} | E_{1/2} | |
| Complex | processes | (ΔEₚ)/V | (ΔEₚ)/V | Solvent |
| [Re(2,9-Me₂-4,7-Ph₂-phen)(CO)₃Cl] 1 | Reversible | +1.00 | −1.92 | CH₂Cl₂ |
| | oxidation and | (0.22) | (0.22) | |
| | reduction | | | |
| [Re(dppt)(CO)₃Cl] 2 | Reversible | E [symbol] = +1.06 | −1.35 | CH₂Cl₂ |
| | reduction, | | (0.16) | |
| | irreversible | | | |
| | oxidation | | | |
| [Re(CO)₃(2,4,7,9-Ph₄phen)Cl] 5 | Reversible | +0.86 V | −1.84 V | CH₂Cl₂ |
| | oxidation and | (0.064) | (0.064) | |
| | reduction | | | |
| [Re(2,2′-bpz)(CO)₃Cl] 8 | Reversible | — | −1.23^{(a)} | DMF |
| | reduction only | | (0.075) | |
| [Re(2,2′-bpz)(CO)₃Br] 9 | Reversible | — | −1.23^{(a)} | DMF |
| | reduction only | | (0.1) | |
| [Re(CO)₃ {2,9-(4-CF₃Ph)₂-4,7- | Reversible | +0.97 V | −1.76 V | CH₂Cl₂ |
| Ph₂phen}Cl] 10 | oxidation and | (0.16) | (0.21) | |
| | reduction | | | |
| [Re(CO)₃ {2,9-(3-CF₃Ph)₂-4,7- | Reversible | +0.94 V | −1.76 V | CH₂Cl₂ |
| Ph₂phen}Cl] 11 | oxidation and | (0.092) | (0.079) | |
| | reduction | | | |
| [Re(2,2′-biq)(CO)₃Cl] 12 | Reversible | — | −1.41 | CH₂Cl₂ |
| | reduction only | | (0.15) | |

All potentials are quoted relative to Fc/Fc⁺ and were recorded in solutions with ˜0.2 M [Bu^{t}N][PF₆] as the electrolyte and a scan rate of 0.1 V/s using a glassy carbon working electrode, a platinum auxiliary electrode and a silver wire pseudo reference electrode. For (a) the data is from Organometallics, 1996, 236.

Complexes 8 and 9 both show more positive reduction potentials than 1 and are both luminescent although they are very weak both in solution and as solids. The λ_{max em} of 9 is 641 nm and it has CIE coordinates of 0.670, 0.329 which is a near-perfect red. The low efficiency of the emissions with bpz ligands has been attributed to the basicity of the ligand and the potential for deactivation through interactions at the non-coordinated nitrogen donors (J. Organometallic Chem., 1989, 107).

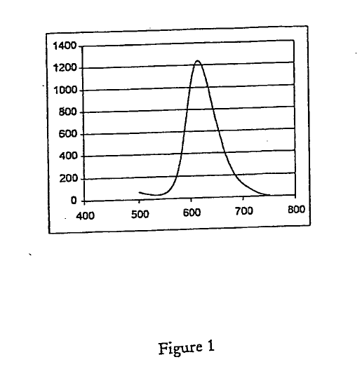

Complex 2 is a red emitting complex with CIE coordinates in the solid state of x=0.632 and y=0.366 with a brightness in the solid state comparable to the red-emitting Ir(III) complex, [Ir(btp)₂(acac)]. The emission spectrum of 2 as a solid is shown in FIG. 1, λ_{max em} is 617 nm.

Device Studies

Complexes 1, 2 and 11 have been investigated as emitting materials in EL devices.

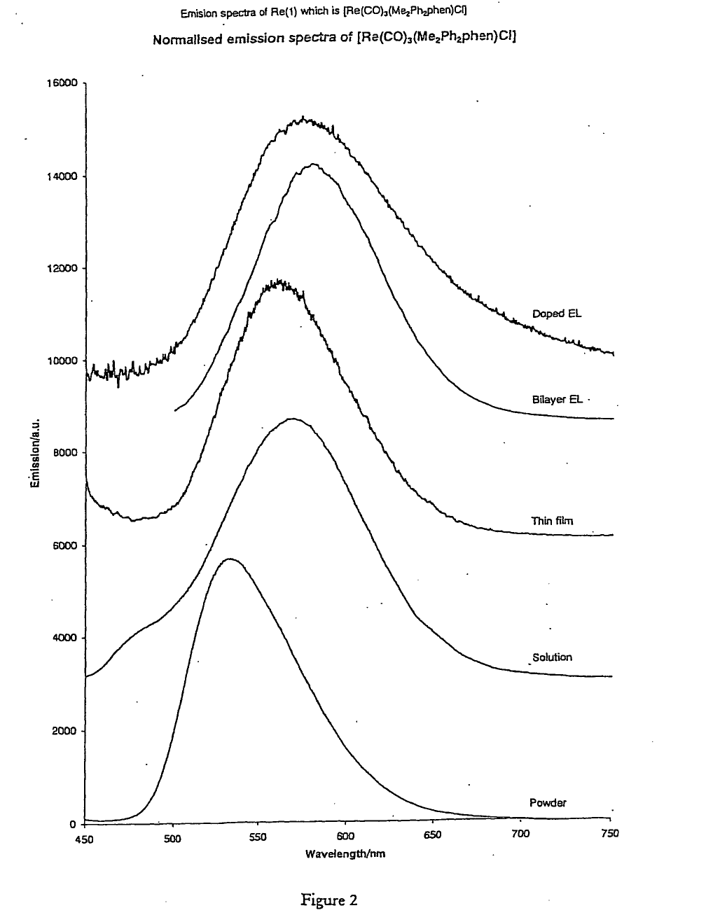

Double layer devices with NPD and 1 emit yellow/orange light at a wavelength similar to the solution PL spectrum as shown below in FIG. 2.

More efficient multi-layer devices were made with complex 1 doped into carbozoyl diphenyl (CBP) at various concentrations. Complex 1 was used in devices with the structure ITO/NPD (50 nm)/1: CBP (30 nm)/BCP (60 nm)/LiF (1.2 nm)/A1 (100 nm). Over the range of doping ratios studied a doping ratio of 1:7 (w/w) proved optimal. BCP (2,9-dimethyl-4,7-diphenyl-1,10-phenanthroline) was used as an electron transporting/hole blocking layer. Such a layer is beneficial for improving the efficiency. The best device efficiency was >6 lm/W and ˜4 lm/W @ 100 cd/m².

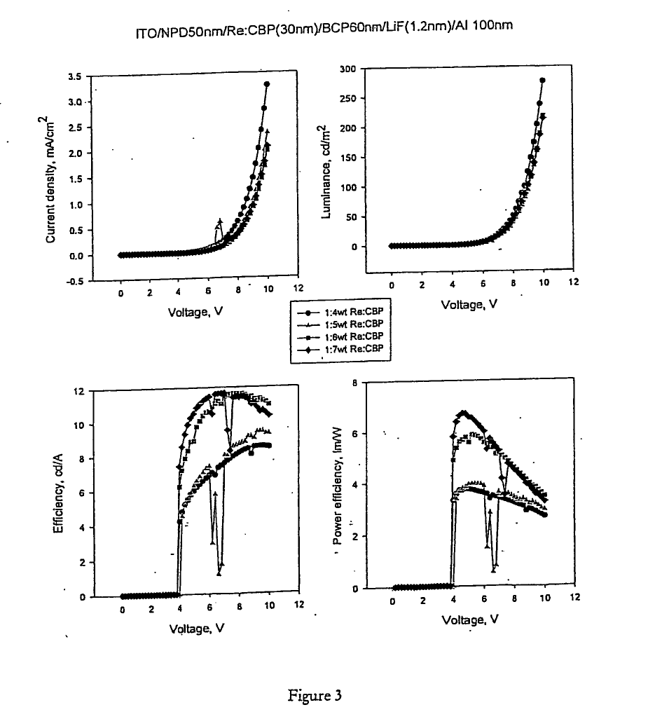

The device characteristics are given in FIG. 3.

A double layer device with a layer of NPD and a layer of 11 emits red light with CIE coordinates 0.619, 0.371 at 13V.

1. An organic electroluminescent device which comprises a compound having a skeleton of the formula: 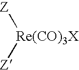
which skeleton can comprise one or more additional aromatic rings, wherein each of Z and Z′, which may be the same or different, represents a nitrogen-containing aromatic ring such that the Z and Z′ rings either together form a conjugated system, optionally with one or more additional aromatic rings, or at least one of Z and Z′ form a conjugated system with one or more additional aromatic rings to which Z and Z′ is attached, with the proviso that, (a) when the two said rings are pyridyl rings and are connected to one another ortho to the nitrogen atoms then (i) at least one said ring is substituted by at least one electron withdrawing substituent which is a hydrocarbon aryl group or (ii) at least one said ring is fused to another aromatic ring to which the other pyridyl ring is not fused or (iii) the two said rings together form a phenanthroline ring system which is substituted by at least one electron withdrawing substituent which is in the 2, 4, 5, 6, 7 or 9 position, or (b) the two said rings are such that either (i) at least one of them contains at least one further nitrogen atom or (ii) they are fused to another aromatic ring which contains at least one nitrogen atom, and X represents an anionic or neutral coligand.

2. A device according to claim 1 where Z and Z′ togther represent a structure of the formula: 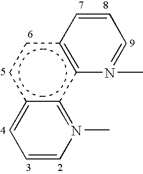
where the dotted lines are absent or complete a six membered aromatic ring.

3. A device according to claim 2 wherein the electron withdrawing group is a phenyl group.

4. A device according to claim 1 wherein the skeleton comprises at least three ring nitrogen atoms which form part of a conjugated system.

5. A device according to claim 4 wherein Z and Z′ together form the group

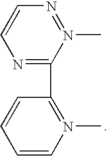

6. A device according to claim 1 wherein Z and Z′ both represent

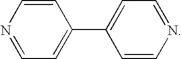

7. A device according to claim 1 wherein at least one of the rings of the conjugated system possesses at least one electron withdrawing substituent.

8. A device according to claim 7 wherein the electron withdrawing group comprises a nitro; nitroso; cyano; thiocyano; cyanato; aldehyde; ether; carboxylic acid; azide; aryl; heteroaryl; halogen; ester; chalcogenoester; fluoroalkyl; hypophosphate; sulfonate; acylhalide; amide; substituted N-oxide; hydrazide group; quaternary amine; silyl or substituted, bivalent chalcogenide.

9. A device according to claim 8 wherein the electron withdrawing group is phenyl, 4-pyridyl, pyrazole, furan, thiophene, fluorine, chlorine, bromine, iodine, ethoxycarbonyl, CH₃EO₂ or phenyl EO₂ where E is S, Se or Te, trifluoromethyl, pentafluoroethyl, p-toluene, sulfonate, —CONH₂, —CONHR or —CONR₂ where R is hydrogen, alkyl or aryl, —NOCH₂, —NR—NR′₂ where R is as defined above and R′ is as defined for R, tetraalkylammonium, CH₃Se or CF₃S, trifluoromethylphenyl, pentafluoroethyphenyl or pentafluorophenyl group.

10. A device according to claim 1 wherein X represents an anionic coligand.

11. A device according to claim 1 wherein the compound possesses a substituent capable of undergoing radical, cationic or anionic polymerisation.

12. A device according to claim 1 wherein the compound possesses a substituent which forms part of a dendritic structure such that the molecule is a dendrimer.

13. A device according to claim 1 wherein the compound posseses an olefin substituent capable of photopolymerisation.

14. A device according to claim 1 wherein the compound is the light-emitting material in the device.

15. A device according to claim 1 wherein the compound is Re(CO)₃ 5,6-diphenyl-3-(2-pyridyl)1,2,4-triazinyl Cl.

16. A device according to claim 1 which comprises a transparent substrate layer, a transparent electrode, a layer of light emitting material and a second electrode, said light emitting material comprising said complex.

17. A device according to claim 16 wherein a hole blocking/electron injecting layer is present between the layer of light emitting material and the electrode forming the cathode.

18. A device according to claim 1 wherein the complex is blended with a host material.

19. (canceled)

20. A compound having the skeleton defined in claim 1 which skeleton can comprise one or more additional aromatic rings, each of Z and Z′, which may be the same or different, represents a nitrogen-containing aromatic ring such that the Z and Z′ rings either together form a conjugated system, optionally with one or more additional aromatic rings or at least one of Z and Z′ form a conjugated system with one or more additional aromatic rings to which Z or Z′ is attached, with the proviso that the two said rings are such that either (i) at least one of them contains at least one further nitrogen atom or (ii) they are directly fused to another aromatic ring which contains at least one nitrogen atom, and X represents an anionic or neutral coligand, other than Re(CO)₃[5,6-diphhenyl-3-(2-pyridyl)1,2,4-triazinyl]Cl and Re(CO)₃[3,5,6-tri(2-pyridyl)-1,2,4-triazinyl]Cl.

21. A compound according to claim 20 wherein the skeleton comprises at least three ring nitrogen atoms which form part of a conjugated system.

22. A compound as defined in claim 1 in electroluminescent device.
